(19) United States
(12) Patent Application Publication
(10) Pub. No.: US 2010/0222964 A1
(43) Pub. Date: Sep. 2, 2010

(54) Method for Controlling the Steering Angle of the Vehicle Guiding Wheels

(75) Inventor: Francois Dechamp, Cluny (FR)

Correspondence Address: NOVAK DRUCE AND QUIGG LLP (Volvo), 1000 LOUISIANA STREET, FIFTY-THIRD FLOOR, HOUSTON, TX, 77002, US

(73) Assignee: RENAULT TRUCKS, Saint Priest (FR)

(21) Appl. No.: 11/993,051

(22) PCT Filed: Jun. 24, 2005
(86) PCT No.: PCT/FR05/50494

§ 371 Date: Aug. 1, 2008

(51) Int. Cl. G06F 19/00

(52) U.S. Cl. 701/41

(57) ABSTRACT

The invention relates to a method for controlling the steering angle β of the guiding wheels of a vehicle (1) consisting of a tow truck (2) and a trailer (8) hinged with respect thereto. The inventive method makes it possible to produce an instruction β₀ usable by an actuator acting on the steering angle β. The inventive method used during a reverse running consists in selecting a target point (C), which the vehicle path should pass through, in determining the instruction for an angle θ_{c} between the axes of the truck and trailer according to said target point (C) and the vehicle geometry and in controlling the steering angle β of the guiding wheels according to a close-loop control for slacking the measured steering angle ? between the truck and trailer axes towards the instruction value of the angle θ_{c}.

### TECHNICAL FIELD

The invention relates to a method for controlling the steering of a vehicle, particularly an industrial vehicle of the truck type. It relates more specifically to coupled vehicles comprising an articulation between a tractor and a trailer. This may therefore be a vehicle of the semitrailer type in which the semitrailer is articulated to a tractor at a fifth wheel. This may also be a coupling involving a truck of the type that carries a payload, behind which a trailer is articulated.

The invention relates more specifically to vehicles in which the steering is performed without a mechanical steering column but via an electrical, electro-hydraulic or hydraulic control circuit controlling an actuator that influences the steering angle of the steered wheels. This type of steering control is generally termed “steer-by-wire”.

The invention therefore more specifically relates to a method for controlling the steering angle of the steered wheels, which method is intended to facilitate the work of the driver during backing-up maneuvers. The problem is that, given the articulation between the tractor and the trailer, backing-up maneuvers that are not in a straight line require operations of applying steering lock and opposite lock to be strung together in an appropriate sequence.

### PRIOR ART

As already mentioned, backing-up maneuvers, for example when coming up alongside a platform or parking, require a certain amount of skill on the part of the driver given the articulation between the two parts of the vehicle. This skill is all the more necessary given that the direct field of view of the driver is relatively limited, if not non-existent because the rear view mirrors are mounted on the tractor vehicle and are unable to provide a view of the space behind the trailer when this trailer is not perfectly aligned with the tractor.

To make backing-up maneuvers easier in various vehicles there are solutions that have already been proposed and that employ an image acquisition device situated at the rear of the vehicle and providing a view of the space behind the trailer. Systems such as these have been described in particular in documents DE 101 42 367, U.S. Pat. No. 6,366,221 and U.S. Pat. No. 6,564,122.

In document WO 2004/022413 the applicant has described a device which, on the one hand, allows the field of view behind the vehicle to be displayed directly without inverting the image as a mirror would do and, on the other hand, to reverse the direction in which the wheels are turned under the action of moving the steering wheel.

This makes driving while backing up easier insofar as the driver is positioned in virtual terms behind the vehicle. This system is well suited to vehicles of the type that carry a payload. By contrast, with articulated vehicles, there is still the need for the driver to string together the operations of applying steering lock and opposite lock appropriately in order to perform the backing-up maneuver.

The driver's points of reference may change from one truck to another according to the wheelbase of the tractor, the location of the point of articulation, and the length of the trailer.

### SUMMARY OF THE INVENTION

It is an objective of the invention to make backing-up maneuvers in articulated vehicles easier. The invention therefore relates more specifically to a method for controlling the steering angle of the steered wheels of a coupled vehicle comprising a tractor and a trailer that is articulated with respect to the tractor. This method makes it possible to formulate setpoint values to be applied to an actuator that influences the steering angle.

According to the invention, during the backing-up maneuvers:
a target point through which the path of the vehicle is to pass is selected;
a setpoint value is determined for the angle between the axis of the trailer and the axis of the tractor as a function of the location of the target point and of the geometry of the vehicle;
the steering angle for the driving wheels is controlled as the result of feedback control that causes the measured angle between the axis of the trailer and that of the tractor to tend toward this precalculated setpoint value.

In other words, the invention consists in contriving for the steering system to be driven automatically during backing-up maneuvers so as to bring the vehicle to a point predetermined by the driver. The device for controlling the actuator responsible for the steering angle drives this actuator in such a way as to bring the coupling into a configuration that allows the aim point to be reached. The phases of applying the steering lock and opposite lock are therefore strung together automatically in such a way that, at the end of the maneuver, the aim point is reached. This operation is therefore performed with no intervention on the part of the driver on the steering control member, which is disabled. The driver acts only on the throttle control.

The target point can be selected in different ways.

Thus, in a first alternative form, the selection of the target point may be displayed in the cab, on a display screen that provides a view of the field of view behind the vehicle. In this case, the driver can constantly see the point he has preselected, for example in the form of a sighting mark present on a screen. Actual selection of the target point is done by action on a steering control member, typically the steering wheel, because the steering control device will provide automatic control of the actuator.

In practice, the driver can change the position of the target point by action on his steering wheel during the automated backing-up maneuver. He can also log the position of the target point at the start of the maneuver, this position being stored in memory and potentially updated on the display screen through a recalculation that takes account of the movement of the vehicle and therefore the change in the rear field of vision.

In another alternative form, the target point may be selected automatically by choosing a maneuver that is to be performed. More specifically, when the vehicle is in a position close to parking areas, it is possible to offer the driver a choice of various maneuvers, such as performing a parallel parking maneuver, parking at a predetermined angle, or parking by turning through 90° to the left or to the right. Once the driver has selected the maneuver that he wishes to perform the steering actuator control device acts in accordance with the method, autonomously.

Advantageously, in practice, at the time that it is selected, the selected target point may lie a predetermined distance behind the trailer. In other words, the target point can be detected by its coordinates in a frame of reference associated with the trailer, one axis of which frame of reference corresponds to the longitudinal axis of the trailer. In such a case, the target point has one coordinate fixed in this frame of reference and can deviate laterally from the axis of the trailer.

The determining of the steering angle control may take into consideration several components that can advantageously be combined.

Thus, a first component in the control of the steering angle is a function of the radius of curvature of the path of the point at which the trailer is articulated to the tractor. This radius of curvature is determined with respect to the geometry of the vehicle and, in particular, with respect to the position of the fixed rear axle of the trailer and the position of the aim point.

Control of the steering angle may incorporate a second component which is a function, particularly using proportional and/or integral and/or derivative processing, of the difference between the actual angle measured between the axes of the tractor and of the trailer and the optimum setpoint angle at the coupling.

In practice, control of the steering angle of the wheels may include an additional component which is taken into consideration when the angle between the axes of the tractor and of the trailer crosses a predetermined threshold in order to reduce this angle. This is because it is important for the steering control not to lead to a configuration in which the tractor deviates too greatly from the axis of the trailer, at the risk of striking the trailer and resulting in a position commonly referred to as “jack-knifing”.

### BRIEF DESCRIPTION OF THE DRAWINGS

The embodiment of the invention and the ensuing advantages will become clearly apparent from the description of the embodiment which follows, with the support of the attached figures in which:

FIG. 1 is a brief perspective view of a truck moving around in an environment in which the invention can be implemented.

FIG. 2 is a brief perspective view of the interior of a cab of a vehicle implementing the method according to the invention.

FIG. 3 is a flow diagram schematically showing how the steps of the invention are strung together.

FIG. 4 is a simplified diagram showing how the various steps of the invention work.

FIG. 5 is a schematic plan view of a truck depicting the various angles and distances used in implementing the invention.

FIG. 6 is a view similar to FIG. 5, showing the truck in a particular configuration.

### EMBODIMENT OF THE INVENTION

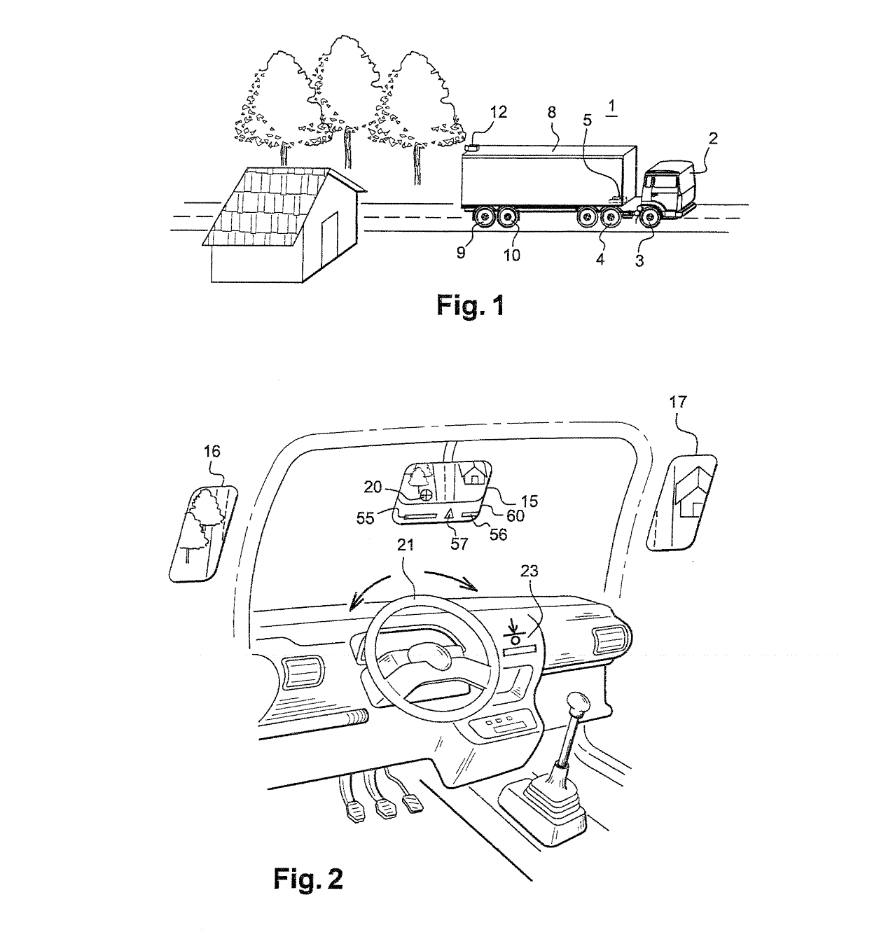

As already mentioned, the invention relates to a method for controlling the steering angle of the steered wheels of an articulated vehicle, as illustrated in FIG. 1. A vehicle 1 such as this therefore comprises a tractor 2 comprising two axles 3, 4 and a fifth wheel to which the point of attachment of a trailer 8 is articulated. This trailer 8 at the rear comprises two axles 9, 10 and an image acquisition device 12 depicted schematically on the upper wall of the trailer 8.

As illustrated in FIG. 2, this image acquisition device 12 allows the rear field of view of the vehicle to be displayed on a screen 15. In FIG. 2, this screen 15 is positioned in the middle at the top of the windshield, but it goes without saying that it could be positioned at some other location, without departing from the scope of the invention.

Thus, in combination with the two, left and right, rear-view mirrors 16, 17, the driver has available to him various complementing fields of view which do not necessarily overlap if the trailer 8 and the tractor 2 are not aligned.

The field of view displayed on the screen 15 may be inverted, as it is in the external rear-view mirrors, in order to avoid confusing the frames of reference of the driver. However, it may equally be a direct view according to the teachings of patent WO2004/022414.

According to the invention, the driver can select a target point through which he wishes the path of his vehicle to pass, while backing up. FIG. 2 illustrates an example in which this selection is made via the screen 15 that displays the field. More specifically, on beginning the backing-up maneuver and for example therefore on engaging a reverse gear, the driver can switch to target-selection mode by moving a sighting mark 20 over the screen 15 using his steering wheel 21. Moving the steering wheel offsets the sighting mark laterally in one direction or the other, and the calculation characteristic of the invention is therefore performed correctly.

It is also possible for the target point to be selected in two stages, namely an aiming, followed by a confirmation, for example, using a button 23, or a switch or the like. Thus, when the sighting mark 20 coincides with the target point at which the driver is aiming, the driver validates this position and this initiates the calculation characteristic of the invention.

It is also possible, in unillustrated alternative forms of embodiment, to select the maneuver that is to be performed and therefore a target point by choosing a maneuver of the parallel parking type, pulling over to the right or to the left for example.

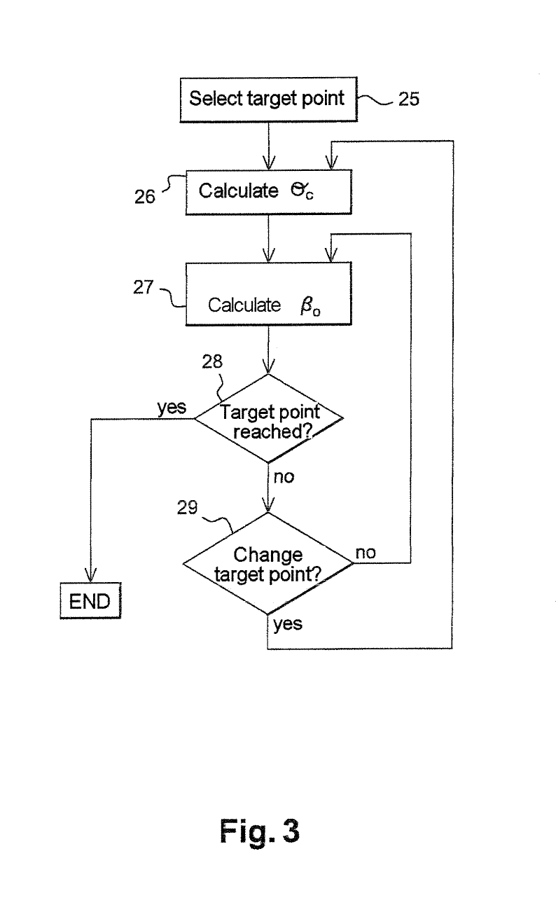

As illustrated in FIG. 3, the method according to the invention therefore involves a first step 25 during which the driver selects the target point through which the path of the vehicle is to pass. Next, once this selection has been made, the method continues with a step 26 of calculating the angle θ_{c} corresponding to the ideal angle that the axis of the tractor needs to adopt with respect to the axis of the trailer. This first calculation, in a step 27, leads to calculation of the steering angle setpoint value β₀ which is applied to the device controlling the actuator responsible for varying the steering angle of the steered wheels. This method continues as long as the target point is not reached, the check on this being performed in step 28.

If the driver does not alter the target point, according to the test at 29, then the method continues, without a break, with calculation 27 of the steering angle setpoint value β₀. What actually happens is that because of the dynamics of the vehicle, the steering maneuvers will mechanically cause the angle θ of the articulation between the tractor and the trailer to change, and this factor is fed into the calculation of the steering angle setpoint value β₀ in the way explained hereinafter.

By contrast, if the driver does change his selection of target point, for example by action on the knob 23 (FIG. 2) and by validating this new target, then a new calculation 26 of the angle θ_{c} is performed and the method continues with a new calculation of the steering angle setpoint value β₀ in step 27.

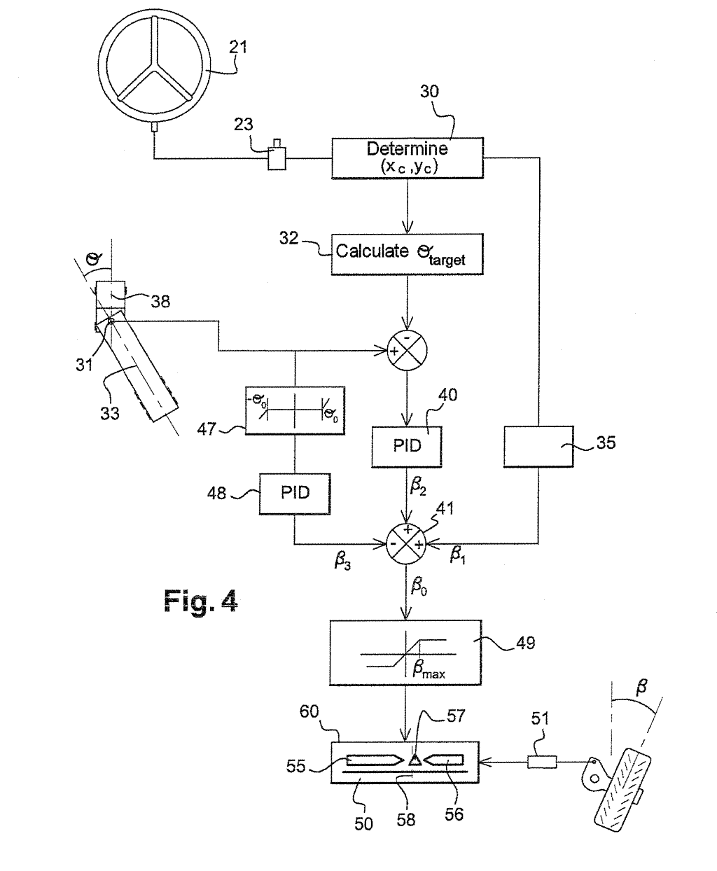

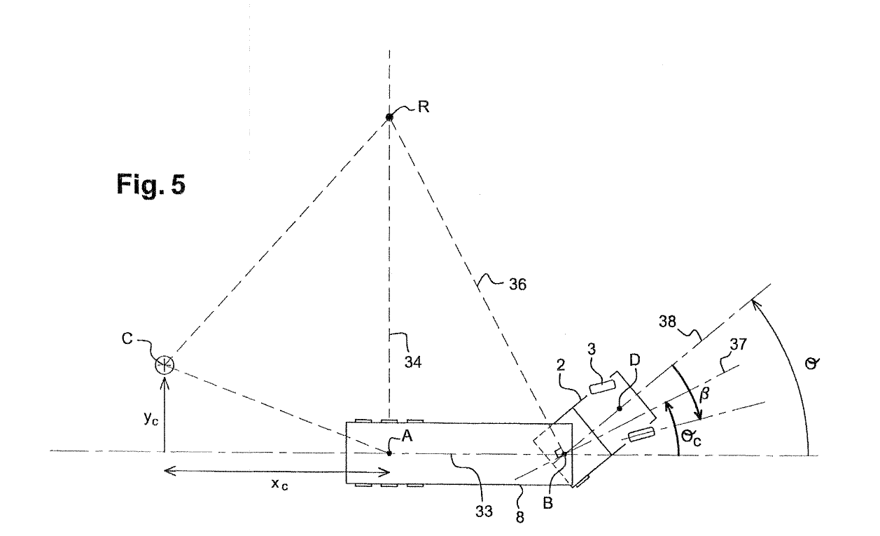

The way in which the method is run is shown in detail in FIG. 4 in combination with FIG. 5 which shows the points and axes characteristic of the method. Thus, once the driver has determined, using his steering wheel 21, the position of the target point and has possibly validated it by acting for example on an appropriate switch or selector 23, the method according to the invention is initiated by determining at 30 the target aim point C, visible in FIG. 5. This determining consists in converting the position of the sighting mark 20 present on the screen 15 into target point coordinates. This determining is done by calculating the coordinates x_{c}, y_{c} of this point C in a frame of reference based on the point A, situated in vertical alignment with the fixed rear axle of the trailer. When the trailer has several fixed rear axles, this point A is situated midway between the axles. The characteristic frame of reference is therefore formed by the axis 33 of the trailer and a perpendicular axis 34 passing through the point A. It is assumed at the time of selection that the target point C lies at a coordinate x_{c} along the axis 33 that adopts a predetermined value which can range up to about a few tens of meters. The target point can deviate laterally from the axis 33 of the trailer. The position of the sighting mark 20 on the screen therefore corresponds to a lateral deviation of the sighting mark with respect to the axis 33 of the trailer, which deviation is converted into the coordinate y_{c} along the axis 34 of the frame of reference. This being the case, moving the sighting mark 20 in just a horizontal direction is enough to determine the position of the target point C.

Thus, it is possible to calculate the position of the ideal center of rotation R situated at equal distances from the aim point C and from the point A, located at the rear axle, this center of rotation R being aligned with the axis 34 passing through the rear axle. Because this axis 34 is perpendicular to the axis 33 of the trailer, the point R is thus clearly defined.

This center of rotation R makes it possible to determine the line along which the thrust exerted by the tractor needs ideally to be applied to the point B at which the trailer is articulated to the tractor. This thrust needs ideally to be exerted along a line 37 which is perpendicular to the straight line 36 connecting the center of rotation R to the point of articulation B.

Thus, in step 32, it is possible to determine the value of an angle θ_{c} corresponding to the ideal angle that the axis of the tractor 38 needs to adopt with respect to the axis of the trailer 33. In numerical terms, and by applying basic geometric principles, this setpoint angle has the value

$${θ}_{c} = {tan}^{- 1} ( \frac{AB}{\frac{{y}_{c}}{2} + \frac{{x}_{c}^{2}}{2 {y}_{c}}} ) ,$$

where x_{c}, y_{c} are the coordinates of the target point C in the frame of reference mentioned earlier.

An angle sensor 31 positioned at the articulation point B can be used to measure the actual measured angle θ between the axis 33 of the trailer and that 38 of the tractor.

According to the invention, the feedback control used to control the steering angle combines several components that can be added together.

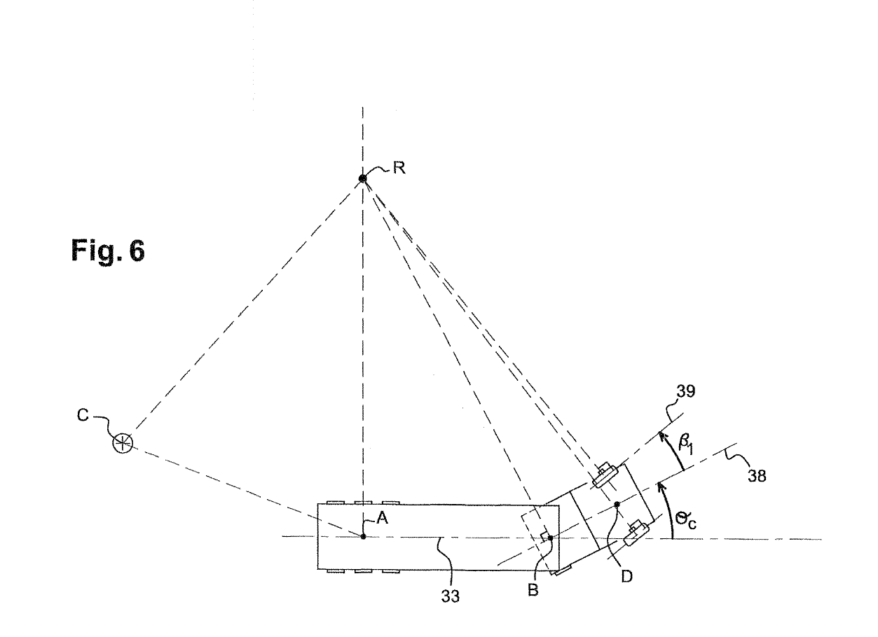

A first component is calculated, in step 35, from the position of the point of rotation R combined with the geometry of the vehicle and more specifically of the tractor. This first component β₁ is aimed at directing the steered wheels optimally when the angle between the axis 38 of the tractor and the axis 33 of the trailer reaches the abovementioned setpoint angle value for θ_{c}. This configuration, which is illustrated in FIG. 6, is such that the planes 39 of the wheels are substantially tangential to circles of center R. This first component β₁ is therefore dominant when the tractor and the trailer are at an angle to one another that is close to the value θ_{c}, and therefore in particular toward the end of the maneuver.

By taking account of approximations regarding the parallelism of the steered wheels, the first component β₁ an be calculated as follows:

$${β}_{1} = {tan}^{- 1} ( \frac{DB}{RB} ) ,$$

in which BD is the distance separating the point of articulation B from the location of the point D situated at the steered axle of the tractor, and RB is the distance separating the ideal point of rotation R from the point B at which the trailer is articulated to the tractor, namely, by applying basic geometric principles,

$$RB = \sqrt{{( \frac{{y}_{c}}{2} + \frac{{x}_{c}^{2}}{2 {y}_{c}} )}^{2} + {AB}^{2}} .$$

Calculation of the steering angle setpoint value β₀ may include a second component β₂ resulting from a processing of the difference between the actual angle θ and the setpoint angle θ_{c}. The purpose of this second component is to allow the vehicle to attain the path in which the angle between the tractor and the trailer has reached the setpoint value θ_{c}. It is therefore predominant at the start of the maneuver when the coupling is in a configuration far removed from the configuration which should ideally lead to the target point and which is illustrated in FIG. 6. The difference (θ−θ_{c}) can be filtered by a PID regulator 40 to give rise to the second component β₂ used to determine the steering angle setpoint value β₀ using the following equation:

$${β}_{2} = {k}_{2} \cdot ( θ - {θ}_{c} ) + {k}_{3} \cdot \frac{d ( θ - {θ}_{c} )}{dt} .$$

In practice, the coefficient k₂ is determined as a function of the combined wheelbase of the trailer and of the tractor. In order to avoid the need to apply opposite lock excessively swiftly, it is necessary for this coefficient not to be too high. However, it needs to be high enough that it allows the vehicle to attain the desired path as quickly as possible. The coefficient k₃ for the PID regulator 40 provides a damping function and limits the rate of variation of the steering angel setpoint value β₀ when the rate of variation of the angle θ is too great. These coefficients may also be dependent on a possible limitation of the speed of the vehicle, employed when backing up. This is because if the speed is limited, the risks of jack-knifing are lower, and it is then possible to use higher coefficients for the PID 40, giving rise to a more responsive correction.

This second component β₂ is added to the first component β₁ in the summer 41. These two components are important in applying to the device controlling the steering of the steered wheels a setpoint value that will allow the target point to be reached as quickly as possible.

Furthermore, to prevent the truck from jack-knifing if the angle θ becomes too great, a third component β₃ is calculated. This component is taken into consideration by the threshold 47 only when the angle θ exceeds a predetermined value θ₀ beyond which this risk exists. When this risk is present, this component β₃ takes dominance over the first β₁ and second β₂ components mentioned hereinabove. This is because its prime objective is to prevent the tractor from striking the trailer, by injecting an opposite lock component into the steering angle setpoint value β₀, the purpose of this opposite lock component being quickly to oppose the excessive increase in the angle θ, in terms of absolute value. It will, however, be noted that this third component is an optional aspect of the invention insofar as its purpose is automatically to monitor the onset of potential jack-knifing situations, which monitoring could be performed by the driver himself. In other words, the invention covers alternative forms of embodiment in which this third component is not calculated.

This component β₃, following filtering by a PID controller 48, is subtracted from the other two components β₁, β₂, themselves summed, to give the steering angle setpoint value β₀.

Thereafter, this sum β₀ is saturated at 49 to prevent the maximum steering angle βₘₐₓ by the steering system from being exceeded. This angle β₀ is then used as a setpoint value by the device 50 that controls the actuator 51 responsible for varying the steering angle β.

Thus, in the case of a hydraulic actuation, the actuator 51 is supplied in such a way that its piston moves to modify the steering angle β of the associated wheel.

Thus, this steering angle is automatically adjusted with no intervention on the part of the driver as the vehicle progresses toward the target point, along a path which is defined in accordance with feedback control defined hereinabove, as a function of the selected target point.

In practice, the various steps of the method, and in particular the various calculations and feedback controls may be performed by one or more on-board computers using hardware and/or software facilities programmed to do so.

It is evident from the foregoing that the method according to the invention makes it easier to perform the operations of backing up an articulated vehicle in which rear visibility is non-existent, and the maneuvering of which is a complicated matter.

1. A method for controlling the steering angle (β) of the steered wheels of a vehicle (1) comprising a tractor (2) and a trailer (8) that is articulated with respect to the tractor (2), so that a setpoint value (β₀) to be applied to an actuator (51) acting on the steering angle (β) can be formulated, characterized in that, during the backing-up maneuvers:
a target point (C) through which the path of the vehicle is to pass is selected;
a setpoint value (θ_{c}) is determined for the angle between the axes of the trailer (33) and of the tractor (38) as a function of said target point (C) and of the geometry of the vehicle,
the steering angle (β) for the steered wheels is controlled as a result of feedback control that causes the measured angle (θ) between the axes of the trailer and of the tractor to tend toward said setpoint angle value (θ_{c}).

2. The method as claimed in claim 1, characterized in that the selection of the target point (20) is displayed in the cab of the vehicle on a display screen (15) that displays the field of view behind the vehicle.

3. The method as claimed in claim 1, characterized in that the selection of the target point is made by action on the steering control member (21).

4. The method as claimed in claim 1, characterized in that the target point is selected automatically by choosing a maneuver that is to be performed.

5. The method as claimed in claim 1, characterized in that the selected target point (C) is situated at a predetermined distance (x_{c}) behind the trailer.

6. The method as claimed in claim 1, characterized in that control of the steering angle for the steered wheels involves a component (β₁) which is a function of the radius of curvature of the path of the point (B) at which the trailer (8) is articulated to the tractor (2).

7. The method as claimed in claim 1, characterized in that control of the steering angle for the wheels involves a component (β₂) which is a function of the difference between the measured angle (8) between the axes of the tractor (38) and of the trailer (33), and said setpoint angle (θ_{c}).

8. The method as claimed in claim 1, characterized in that control of the steering angle of the steered wheels involves a component (β₃) taken into account when the angle (θ) between the axes (33, 38) of the tractor and of the trailer crosses a predetermined threshold (θ₀) and which is intended to reduce said angle (θ).
